(19) United States
(12) Patent Application Publication
(10) Pub. No.: US 2008/0308694 A1
(43) Pub. Date: Dec. 18, 2008

(54) Stepladder holder with inclined plane

(76) Inventor: Donald Eugene Gorman, Nampa, ID (US)

Correspondence Address: DONALD EUGENE GORMAN, 1604 W. ORCHARD #629, NAMPA, ID, 83651, US

(21) Appl. No.: 11/706,880

(22) Filed: Jun. 18, 2007

(51) Int. Cl. E06C 7/14

(52) U.S. Cl. 248/210

(57) ABSTRACT

The ladder holder, with inclined plane, is a compact one piece unit that keeps an aluminum or fiberglass stepladder securely stored against a wall in a vertical position. Yet it is readily and easily accessed with a slight lifting motion and just as easily put back into the stored position. Installation takes approximately 7 minutes. It doesn't protrude into the room. It has a pleasant appearance and the inclined plane holds the ladder snugly against the wall.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

In July of 2006 I decided to paint the inside of my garage and re-arrange some things. My stepladders were hanging horizontally on hooks screwed into the wall near the ceiling. I came up with this idea for a piece of wood that was inclined so the bottom of the front edge of a step would rest on the inclined plane area. The first one I made was 2 pieces of wood fastened together but it was wobbly. So I came up with this one that is wider and has two mounting holes. A few weeks later I started thinking there might be a market for these because they are so handy and easy to use. They keep the ladder snug against the wall in a vertical position and ready for use.

### PRIOR ART

In searching the Internet, USPTO, and Google's patent search category and visiting home improvement and hardware stores, I have not found anything close to my invention. The closest item I found for this purpose is made of a steel rod shaped to hold a stepladder or other objects. There are also single prong general purpose hooks and hangers.

### OBJECTS AND ADVANTAGES

The ladder grabber

Will be reasonably priced

Will be made of tough injection molded plastic

Has one definite purpose

Is easily installed in about 7 minutes

Doesn't protrude into the room

Has a pleasant appearance

Is easy to use

Stores ladder snug against the wall

Ladder easily removed for use

### DETAILED DESCRIPTION

The ladder holders with inclined plane that I made and use are made of wood. Production of said holders will be injection molded hard plastic.

Said holder is one solid piece of material with no moving parts. Said holder is a very simple item.

### Operation

Said holder is designed to hold an aluminum or fiberglass step ladder in a vertical position against the wall, firm and secure.

With the step side of the ladder facing the wall, the lower front edge of a step rests on the inclined plane area across the upper back side of said holder moving the ladder into contact with the wall, keeping it secure and accessible.

### SUMMARY

The pattern for the ladder holders is made from a solid piece of a wood available at any lumber yard. The tools I used to shape this piece of wood were a table saw with a tiltable blade, a miter saw and a drill press. To smooth the surfaces I used a vibrator sander and a hand held sanding block.

The ladder holder is designed to hold aluminum or fiberglass stepladders firmly, securely, and readily accessible on the wall. The stepside of the ladder will be facing the wall. The lower edge of the step front will rest in the inclined plane cut out area across the upper back side of the holder. The ladder can easily be removed and returned to the ladder holder. As the ladder is properly lowered onto the holder the inclined plane cutout area across the upper back side of the holder slopes to guide the lower front of the step edge to the wall for a snug fit. A slight lifting motion is needed to remove the ladder.

### Comments

If said holder goes into production using injection molding process, the excess material at the two lower comers will probably be eliminated, leaving the inclined plane intact and not compromising the structural value of said holder.

### DRAWINGS

FIG. 1

Front view of the Ladder Holder with inclined plane shows the two holes for mounting on the wall. There are no moving parts. No latch is needed the weight of the ladder holds it securely in place, readily accessible for use.

The ladder is placed on the ladder holder with the lower front edge of the step ladder step over the inclined plane. Lowering the ladder makes contact with the inclined plane, bringing the ladder against the wall,

FIG. 2

I Inclined plane

Side view of said Ladder Holder shows the inclined plane across the upper back side of said holder. When properly used, the inclined plane will hold the step ladder (step side against the wall) securely and ready to be used.

FIG. 3

Cut away side view of said Ladder Holder in use, mounted on a wall.

I. Shows the inclined plane

II. Represents the lower front edge of a step ladder

III. Represents the wall.

Installation is simple; 2 lag screws and approximately 7 minutes.

FIG. 4

Ladder grabber mounted on the wall, with the lower front edge of the stepladder step resting on the inclined plane.

FIG. 5

This angled view shows the inclined plane on the upper back side.

FIG. 6

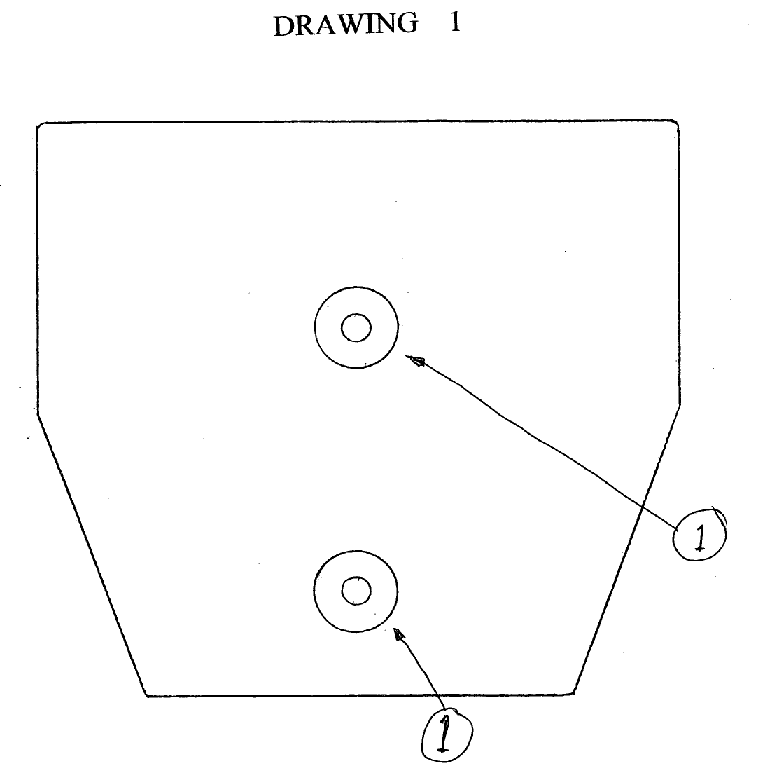

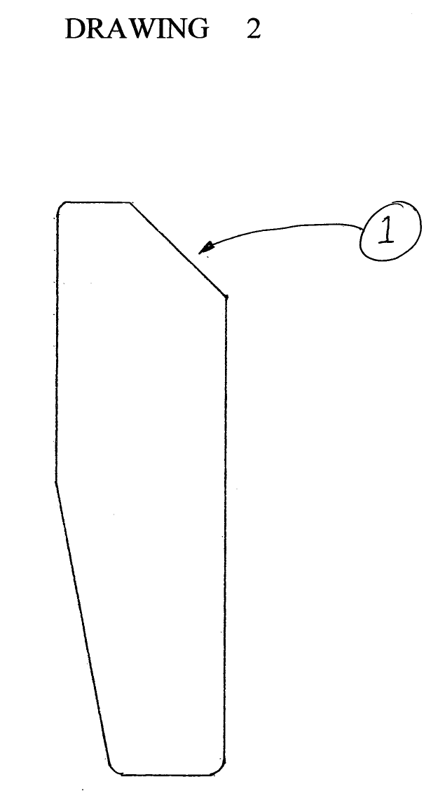

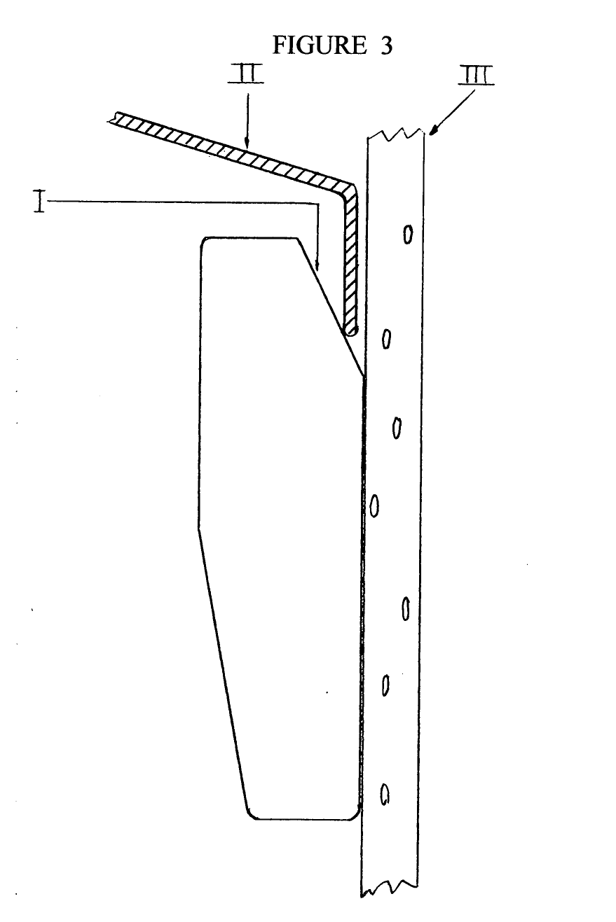

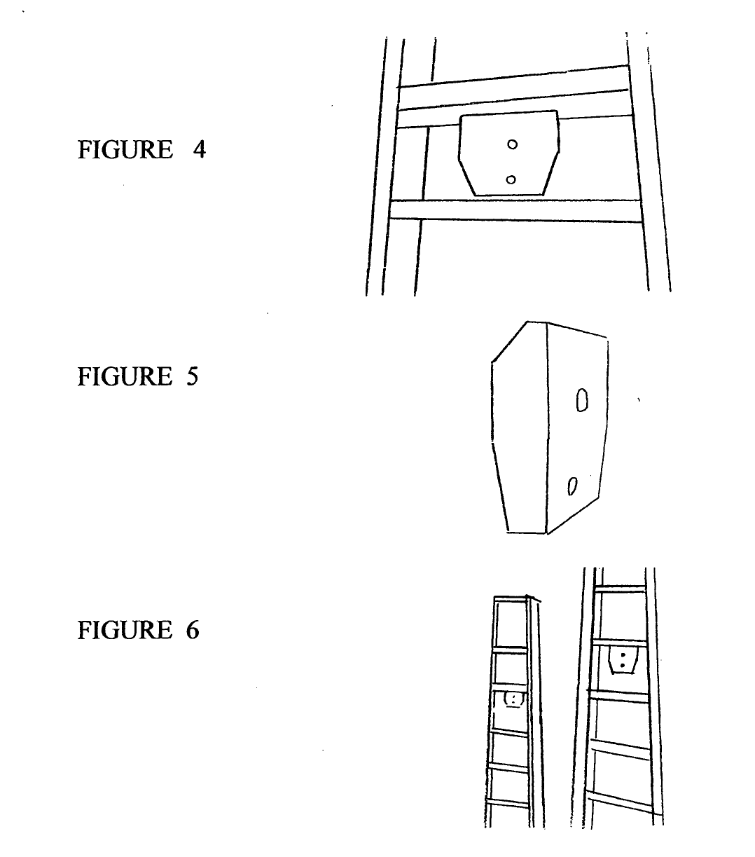

Two ladder grabbers in use on my garage wall.

1-5. (canceled)

6. A method of storing a stepladder when not being used

7. Holder fastens to wall stud using lag screws

8. A device made by plastic injection molding process

9. A device for securing a stepladder vertically

10. Provides easy access to stepladder

11. Aids in organizing storage area
